(19) United States
(12) Patent Application Publication
(10) Pub. No.: US 2018/0368083 A1
(43) Pub. Date: Dec. 20, 2018

(54) Method And Apparatus For Uplink Transmissions In Mobile Communications

(71) Applicant: MediaTek Inc., Hsinchu City (TW)

(72) Inventors: Weidong Yang, San Diego, CA (US); Lung-Sheng Tsai, Hsinchu City (TW)

(21) Appl. No.: 16/010,431

(22) Filed: Jun. 16, 2018

Related U.S. Application Data
(60) Provisional application No. 62/521,314, filed on Jun. 16, 2017.

(51) Int. Cl. H04W 52/52; H04W 52/14; H04W 52/32

(52) U.S. Cl. CPC H04W 52/52; H04B 7/0486; H04W 52/325; H04W 52/146

(57) ABSTRACT

Techniques and examples pertaining to uplink (UL) transmission in mobile communications are described. A processor of an apparatus having a plurality of antenna ports controls a plurality of amplifiers each of which corresponding to a respective antenna port of the plurality of antenna ports that correspond to a plurality of antennas. The processor transmits a reference signal to a network via the plurality of antenna ports. The processor also transmits data through a physical uplink shared channel (PUSCH) to the network via the plurality of antenna ports. The processor controls output powers of the plurality of power amplifiers such that, for at least a first antenna of the plurality of antennas, an amount of power used by the first antenna in transmitting the data and another amount of power used by the first antenna in transmitting the reference signal are equal.

### CROSS REFERENCE TO RELATED PATENT APPLICATION

The present disclosure claims the priority benefit of U.S. Provisional Patent Application No. 62/521,314, filed 16 Jun. 2017, the content of which is herein incorporated by reference in its entirety.

### TECHNICAL FIELD

The present disclosure is generally related to mobile communications and, more particularly, to uplink (UL) transmission in mobile communications.

### BACKGROUND

Unless otherwise indicated herein, approaches described in this section are not prior art to the claims listed below and are not admitted as prior art by inclusion in this section.

For a user equipment (UE) equipped with multiple antenna ports (e.g., eight ports) for mobile wireless communications, there may be a number of practical issues. Firstly, due to the small form factor of a typical UE, in general the antennas need to be packed in a dense area. As a result, there tends to be strong correlation among the multiple antennas of the UE.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method of wireless communication may involve a processor of a user equipment (UE) having a plurality of antenna ports controlling a plurality of amplifiers each of which corresponding to a respective antenna port of the plurality of antenna ports that correspond to a plurality of antennas. The method may also involve the processor transmitting a reference signal to a network node via the plurality of antenna ports. The method may further involve the processor transmitting data through a physical uplink shared channel (PUSCH) to the network node via the plurality of antenna ports. In controlling, the method may involve the processor controlling output powers of the plurality of power amplifiers such that, for at least a first antenna of the plurality of antennas, an amount of power used by the first antenna in transmitting the data and another amount of power used by the first antenna in transmitting the reference signal are equal.

In one aspect, a method of wireless communication may involve a processor of a UE receiving downlink signaling having a plurality of fields from a network node. The method may also involve the processor determining a transmission rank of a plurality of transmission ranks and a sub-band of a plurality of sub-bands based on information indicated in the downlink signaling. The method may further involve the processor transmitting transmit precoding matrix indication (TPMI) signaling to the network node at the determined transmission rank and in the determined sub-band a size of which is based on the determined transmission rank.

In one aspect, an apparatus may include a transceiver and a processor communicatively coupled to the transceiver. The transceiver may include a plurality of power amplifiers and a plurality of antenna ports each corresponding to a respective one of the power amplifiers that correspond to a plurality of antennas. The transceiver may be capable of wirelessly communicating with a network node via the plurality of antenna ports. The processor may be capable of the following: receiving, via the transceiver, downlink signaling having a plurality of fields from the network node; determining a transmission rank of a plurality of transmission ranks, a sub-band of a plurality of sub-bands based on information indicated in the downlink signaling, and transmit precoding matrix for each sub-band according to TPMI signaling within the downlink signaling from the network node at the determined transmission rank and in the determined sub-band a size of which is based on the determined transmission rank; transmitting, via the transceiver, a reference signal to the network node via the plurality of antenna ports; and transmitting, via the transceiver, data through a physical uplink shared channel (PUSCH) to the network node via the plurality of antenna ports. The processor may also be capable of controlling output powers of the plurality of power amplifiers such that, for at least a first antenna of the plurality of antennas, an amount of power used by the first antenna in transmitting the data and another amount of power used by the first antenna in transmitting the reference signal are equal.

It is noteworthy that, although description of the proposed scheme and various examples is provided below in the context of 5th Generation (5G) New Radio (NR) wireless communications, the proposed concepts, schemes and any variation(s)/derivative(s) thereof may be implemented in communications in accordance with other protocols, standards and specifications where implementation is suitable. Thus, the scope of the proposed scheme is not limited to the description provided herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in which different sub-band sizes are used for different transmission ranks in accordance with an implementation of the present disclosure.

FIG. 2 is a diagram of an example of downlink (DL) signaling fields for UL codebook-based transmissions in accordance with an implementation of the present disclosure.

FIG. 3 is a block diagram of an example communications system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

To reduce the correlation among multiple antennas of a UE, the antennas on the UE may be placed at different panels on the UE. Accordingly, the correlation among the antennas can be weakened. Under a proposed scheme in accordance with the present disclosure, multi-panel codebooks may be utilized for UL transmissions in addition to the use of a single-panel Type I codebook. Moreover, the multi-panel codebooks may be expanded to include transmission ranks 5˜8.

For transmission ranks 5˜8, a precoder may follow Type I rank 5˜8 single-panel codebook design with

$${c}_{p , r , l} = \frac{{c}_{r , l}}{{c}_{r , 0}} \times {c}_{p , r , 0}$$

for l=1, 2, 3. Here, {c_{r,0}, c_{r,l}} are defined in Type I single-panel codebook, and c_{p,r,0} is given in the rank 1 multi-panel codebook for each mode except for c_{0,1,0} ∈ {1,j}. In mode 1, calculation and reporting of c_{0,1,0} may be sub-band (e.g., 1 bit/sub-band), and c_{p,0,0} may be wideband (e.g., 2×(N_{g}−1) bits). In mode 2, calculation and reporting of c_{0,1,0} and b_{p,r,o} may be sub-band (e.g., 1+2×(N_{g}−1) bits/sub-band), and a_{p,r,o} may be wideband (e.g., 4×(N_{g}−1) bits).
UL Transmissions with Beamformed SRS

Due to phase discontinuity, ideally an output power of a power amplifier of a UE used for sounding reference signal (SRS) transmissions is the same as that for data transmissions. For analysis in that regard, a non-precoded SRS may be considered. In case there are two transmitting (Tx) antennas with separate power amplifiers at the UE, with power used for the SRS-transmitting antenna port k being qₖ(t₁) (k=1, 2) at time t₁, a base station can measure the SRS transmission from the UE and request a precoder. When the UE transmits a Physical Uplink Shared Channel (PUSCH) with power being qₖ(t₂) at time t₂, if q₁(t₁)≠q₁(t₂) and q₂(t₁)≠q₂(t₂), then a phase difference between Tx antennas at t₂ may be different from that at t₁.

In addition, beamformed SRS may be considered. As an example, a network may configure an N,-port CSI-RS and the UE may estimate an UL covariance matrix R_{N×N} for wideband transmissions with N UL transmit antennas, then eigen-decomposition may be performed on R as expressed below in Equation (1).

$$R = {[ \begin{matrix}{v}_{1} & {v}_{2} & … & {v}_{N}\end{matrix} ] [ \begin{matrix}{s}_{1} & & & \\ & {s}_{2} & & \\ & & ⋮ & \\ & & & {s}_{N}\end{matrix} ] [ \begin{matrix}{v}_{1} & {v}_{2} & … & {v}_{N}\end{matrix} ]}^{H} \qquad ( 1 )$$

Here, vₖ denotes an N×1 unit-norm vector, k=1, . . . , N and sₖ, k=1, . . . , N denote the eigenvalues. Assuming that the UE uses some of vₖ (e.g., v₁ and v₂) for beamformed SRS transmission, then the power emitted from antenna n may be proportional to |v₁(n)|²+|v₂(n)|². Moreover, it is possible that |v₁(n₁)|²+|v₂(n₁)|²≠|v₁(n₂)|²+|v₂(n₂)|², if n₁≠n₂ with 1≤n₁, n₂≤N.

Under a proposed scheme in accordance with the present disclosure, to cope with the aforementioned issue, precoders for SRS may be normalized as expressed below in Equation (2). That is, the power of each antenna to form beamformed SRS may be the same among the powers of the multiple antennas of the UE.

$${\tilde{v}}_{k} = \frac{1}{\sqrt{N}} [ \begin{matrix}{exp}^{\sqrt{- 1} \times angle ( {v}_{k} ( 1 ) )} \\ ⋮ \\ {exp}^{\sqrt{- 1} \times angle ( {v}_{k} ( N ) )}\end{matrix} ] , k = 1 , 2. \qquad ( 2 )$$

Accordingly, precoders for SRS may utilize \tilde{v}ₖ k=1, 2. Alternatively, the UE may also use W1 in a dual-stage codebook for SRS precoding to ensure that each element in the vector has the same amplitude.

With V (e.g., V =[\tilde{v}₁ \tilde{v}₂]) being the precoder matrix applied on SRS, the precoder for PUSCH requested by a network through beamformed SRS may be given by P. To avoid phase discontinuity, it may be imperative to consider what condition(s) needs to be enforced on P. Specifically, in order to satisfy the requirement that phase discontinuity does not occur, a rule that power difference between antennas does not change due to the use of P needs to be enforced, as expressed below in Equation (3).

diag(V·V^{H})∝diag((V·P)(V·P)^{H}) (3)

For UL PUSCH transmissions, the precoder for rank-k may be denoted by VM with a power-scaled beam-selection matrix M=[p₁m₁, p₂m₂, . . . , pᵢmᵢ, . . . , pₖmₖ]. Here, pⱼ are the possible power scaling factors so that the output of the antenna power amplifier for PUSCH is the same as for beamformed SRS. Also, the vector mᵢ, which is the i-th column in the precoding matrix for layer-i with 1≤i≤k, is an all-zero vector except one component is 1 at a selected row, where mᵢ ∈ {e₁, . . . , e_{N}}. Thus, the precoder for rank 1 may be denoted by P ∈ {e₁, e₂, . . . , e_{N}}, with a possible power scaling factor p₁ so that the output of the antenna power amplifier for PUSCH is the same as for beamformed SRS, given the notations expressed below in Equation (4).

$${e}_{1} = {[ \begin{matrix}1 \\ 0 \\ ⋮ \\ 0\end{matrix} ]}_{N \times 1} , {e}_{k} = {[ \begin{matrix}0 \\ ⋮ \\ 1 ← k \text{-} th element \\ 0 \\ ⋮ \\ 0\end{matrix} ]}_{N \times 1} \qquad ( 4 )$$

The precoder for rank 2 may be denoted by P ∈ {[p₁eₘ p₂eₙ]|(m, n)=(1,1), (1,2), (1,3), (1,4), (2,3), (2,4), (3,4)}. The precoder for rank 3 may be denoted by P ∈ {[p₁eₘ p₂eₙ p₃e_{q}]|(m, n, q)=(1,2,3), (1,2,4), (1,3,4), (2,3,4)}. The precoder for rank 4 may be denoted by [p₁e₁ p₂e₂ p₃e₃ p₄e₄], where pⱼ are the power scaling factors. For rank >1, pⱼ may also be used for a water-filling transmission scheme besides being used to meet the requirement regarding the output of the power amplifier.

In view of the above, it is believed that those with ordinary skill in the art would appreciate that, under the proposed scheme in accordance with the present disclosure, the codebook for the beamformed SRS may be based on beam selection.

### Codebook-Based Frequency-Selective Precoding for UL Transmissions

It has been observed up that with downlink control information (DCI)-based signaling, the size of fields for transmission ranks and transmit precoding matrix indication (TPMI), and potentially padding, should be fixed irrespective of the transmission rank and resource allocation. Otherwise, the complexity associated with blind detection may increase exponentially.

With respect to DL NR Type I feedback overhead, frequency-selective precoding for lower ranks (e.g., rank 1) tends to be associated with much higher signaling overhead for sub-band TPMI indication. Under a proposed scheme in accordance with the present disclosure, different sub-band sizes may be used for different ranks. For example, for rank 1 and rank 2, one sub-band having twenty physical resource blocks (PRBs) may be utilized; for rank 3 and higher, one sub-band having five PRBs may be utilized. Accordingly, the signaling overhead for frequency-selective precoding may remain the same irrespective of the transmission rank.

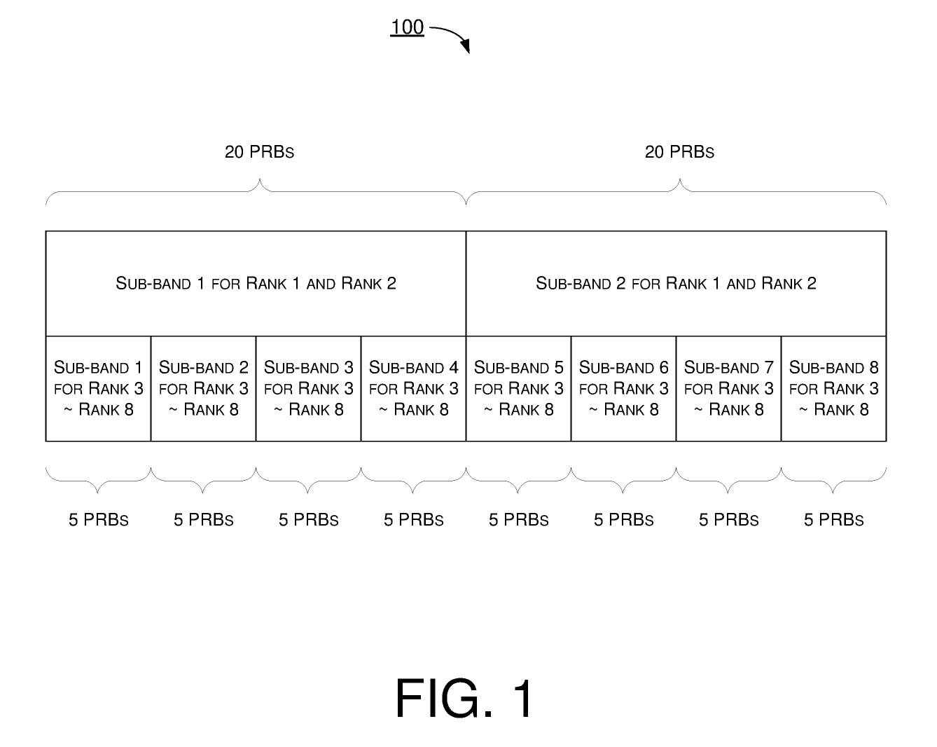

FIG. 1 illustrates an example scenario 100 in which different sub-band sizes are used for different transmission ranks in accordance with an implementation of the present disclosure. Referring to FIG. 1, one or more sub-bands each with twenty PRBs may be utilized for UL transmissions in each transmission rank of rank 1 and rank 2. Moreover, one or more sub-bands each with five PRBs may be utilized for UL transmissions in each transmission rank of rank 3˜rank 8.

Beyond the consideration on signaling overhead, the adaptation of the sub-band size according to transmission rank may also be justified by the relationship between delay spread and angular spread as well as between delay spread and the spatial rank of the propagation channel. As a large delay spread tends to be associated with a higher spatial rank of the propagation channel, if the desired precoding is at rank 1 or rank 2, a larger sub-band size is justified as the channel may not be very frequency-selective.

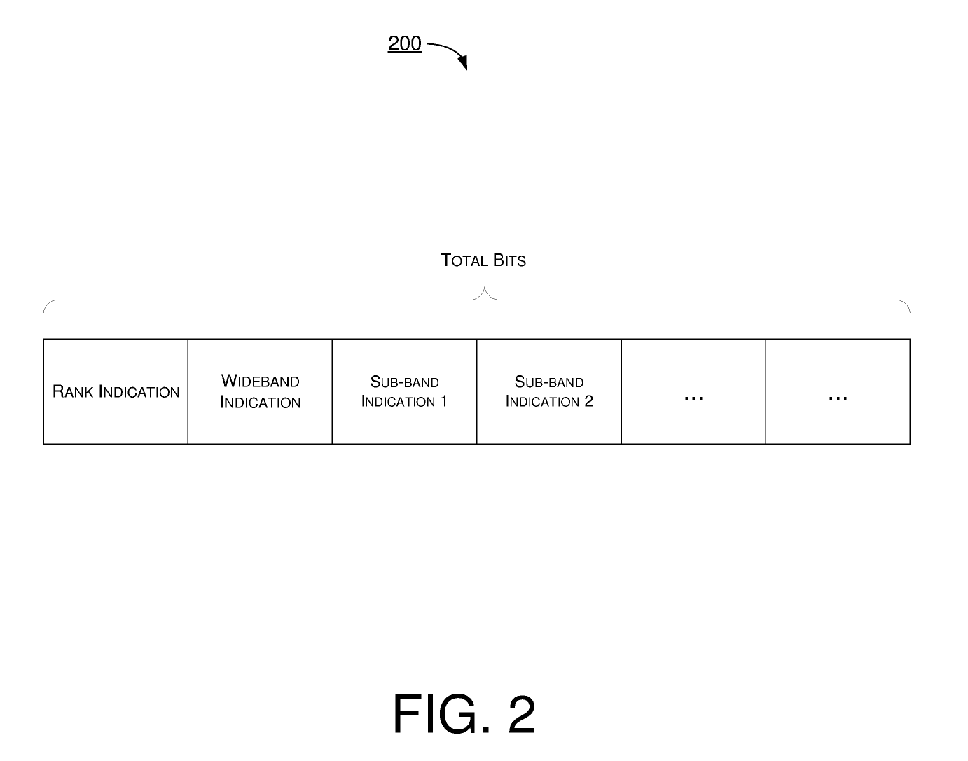

FIG. 2 illustrates an example 200 of DL signaling fields for UL codebook-based transmissions in accordance with an implementation of the present disclosure. Referring to FIG. 2, for DL signaling, which may be in either DCI or media access control (MAC) control element (CE), the number of sub-band TPMI indication fields may be a function of the transmission rank. Each sub-band TPMI indication field is used to derive which precoder should be applied over its associated sub-band. The transmission rank, which is determined from the field “rank indication”, may inform a UE how many fields for “sub-band TPMI indication” are expected. For example, if the size of the sub-band signaling fields is designated or otherwise configured to be 12 bits, then three fields (4 bits each) for sub-band signaling at rank 1 and rank 2 may be accommodated, and twelve fields (1 bit each) for sub-band signaling at rank 3˜rank 8 may be accommodated.

As the maximum allowable UL transmission bandwidth may be different depending on bandwidth adaptation, the sub-band size may be a function of the maximum allowable UL transmission bandwidth in cases in which sub-band TPMIs are signaled via DCI to the UE for all PRBs in UL transmissions regardless of the actual random access (RA) for a given PUSCH transmission. For a UE supporting two, four or eight Tx ports, the UE may report such capability to the network (e.g., eNodeB or gNB). Alternatively, such capability may be inferred by the network from the UE category. The network may configure the UE with the number of Tx antennas and the maximum transmission rank for the UE through radio resource control (RRC) signaling, which may be different from the number of maximum allowable SRS ports. For example, a UE may be configured for eight SRS ports, yet the network may decide to limit the maximum transmission rank to 4 (e.g., rank 4). Furthermore, the number of Tx antennas on a UE may be modified at a more frequent basis through RRC signaling and/or Layer 1 and Layer 2 (L1/L2) signaling, if power saving through such signaling may be beneficial. As the number of Tx antennas is modified, the accompanying maximum transmission rank may also be affected.

With T being the total bits for rank indication and precoding matrix indicator (PMI) indication, the field R for “rank indication” may require 1˜3 bits, depending on the maximum transmission rank for UL transmissions. Assuming the field “wideband signaling” (for W1 in the dual-stage codebook) requires W(r) bits (with W(R) used to make the dependence of the “wideband signaling” size on the transmission rank explicitly), then there may be T−(R+W(r)) bits left for sub-band signaling (for W2 in the dual-stage codebook).

For cases in which sub-band TPMIs are signaled via DCI to the UE for all PRBs in UL transmissions regardless of the actual RA for a given PUSCH transmission, the sub-band size at rank r may be expressed below in Equation (5) or Equation (6).

$$\begin{matrix}⌈ \frac{allowed maximum UL tansmission bandwidth}{T - ( R + W ( r ) )} ⌉ , & ( 5 ) \\ ⌊ \frac{allowed maximum UL tansmission bandwidth}{T - ( R + W ( r ) )} ⌋ , & ( 6 )\end{matrix}$$

For cases in which sub-band TPMIs are signaled via DCI to the UE only for allocated PRBs for a given PUSCH transmission, the sub-band size at rank r may be expressed below in Equation (7) or Equation (8).

$$\begin{matrix}⌈ \frac{allocated UL resources}{T - ( R + W ( r ) )} ⌉ , & ( 7 ) \\ ⌊ \frac{allocated UL resources}{T - ( R + W ( r ) )} ⌋ , & ( 8 )\end{matrix}$$

In view of the above, it is believed that those with ordinary skill in the art would appreciate that, under the proposed scheme in accordance with the present disclosure, the signaling overhead for TMPI may be kept constant while the sub-band size for TMPI signaling is adjusted according to the chosen transmission rank. In the example shown in FIG. 1, the number of bits for rank 1 and rank 2 TPMI per sub-band is greater than the number of bits for rank 3˜rank 8 TPMI per sub-band.

### Illustrative Implementations

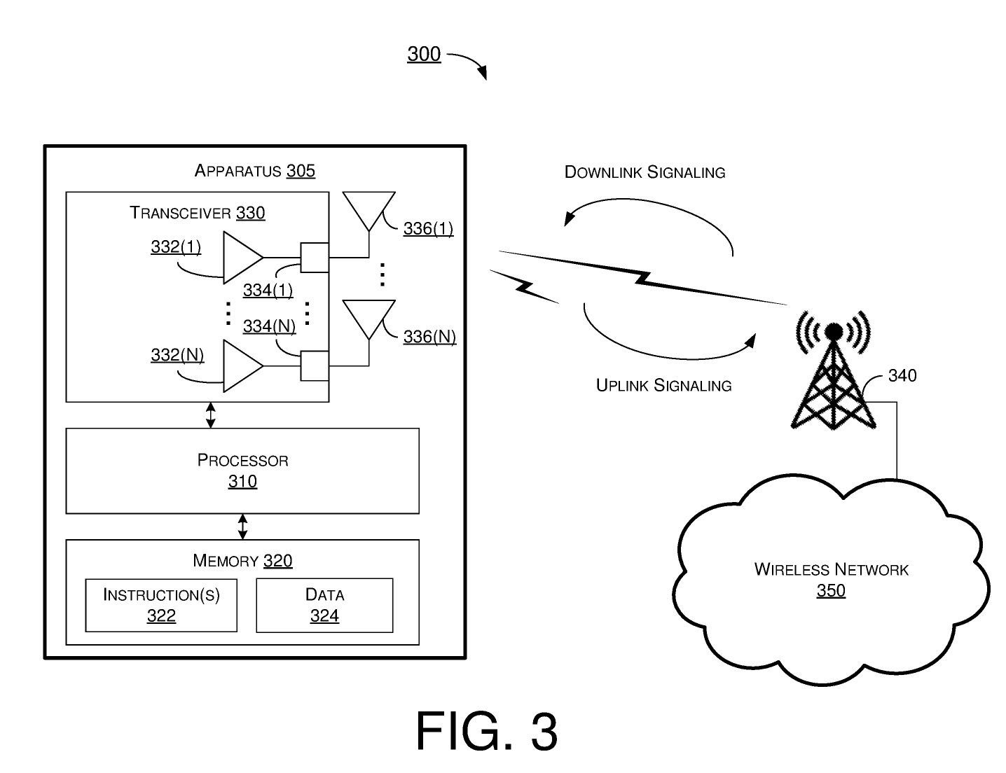

FIG. 3 illustrates an example communications system 300 in accordance with an implementation of the present disclosure. Communications systems may include an apparatus 305, a wireless network 350 and a network node 340 via which apparatus 305 communicates with wireless network 350. Apparatus 505 may perform various functions as a communication device to implement concepts, schemes, techniques, processes and methods described herein pertaining to UL transmission in mobile communications, including those described above as well as processes 400 and 500 described below. More specifically, apparatus 305 may implement various aspects of the proposed concepts and schemes pertaining to UL transmission in mobile communications. Thus, apparatus 305 may be configured to implement each of processes 400 and 500 described below. For instance, apparatus 305 may be implemented as a UE in the context of various implementations and examples in accordance with the present disclosure.

Apparatus 305 may be a part of an electronic apparatus which may be a communication device, a computing apparatus, a portable or mobile apparatus, or a wearable apparatus. For instance, apparatus 305 may be implemented in a Wi-Fi access point, a smartphone, a smartwatch, a smart bracelet, a smart necklace, a personal digital assistant, or a computing device such as a tablet computer, a laptop computer, a notebook computer, a desktop computer, or a server. Alternatively, apparatus 305 may be implemented in the form of one or more integrated-circuit (IC) chips such as, for example and not limited to, one or more single-core processors, one or more multi-core processors, or one or more complex-instruction-set-computing (CISC) processors.

Apparatus 305 may include at least some of those components shown in FIG. 3. For instance, apparatus 305 may include at least a processor 310. Additionally, apparatus 305 may include a memory 320, a transceiver 330 with a plurality of antennas 336(1)˜336(N), where N is a positive integer greater than 1. In some implementations, transceiver 330 may be configured to transmit and receive data wirelessly (e.g., in compliance with one or more 3GPP standards, protocols, specifications and/or any applicable wireless protocols and standards such as LTE, LTE-Advanced and/or 5G NR). Each of memory 320 and transceiver 330 may be communicatively and operably coupled to processor 310. Apparatus 305 may further include other components (e.g., power system, display device and user interface device), which are not pertinent to the proposed scheme of the present disclosure and, thus, are neither shown in FIG. 3 nor described herein in the interest of simplicity and brevity.

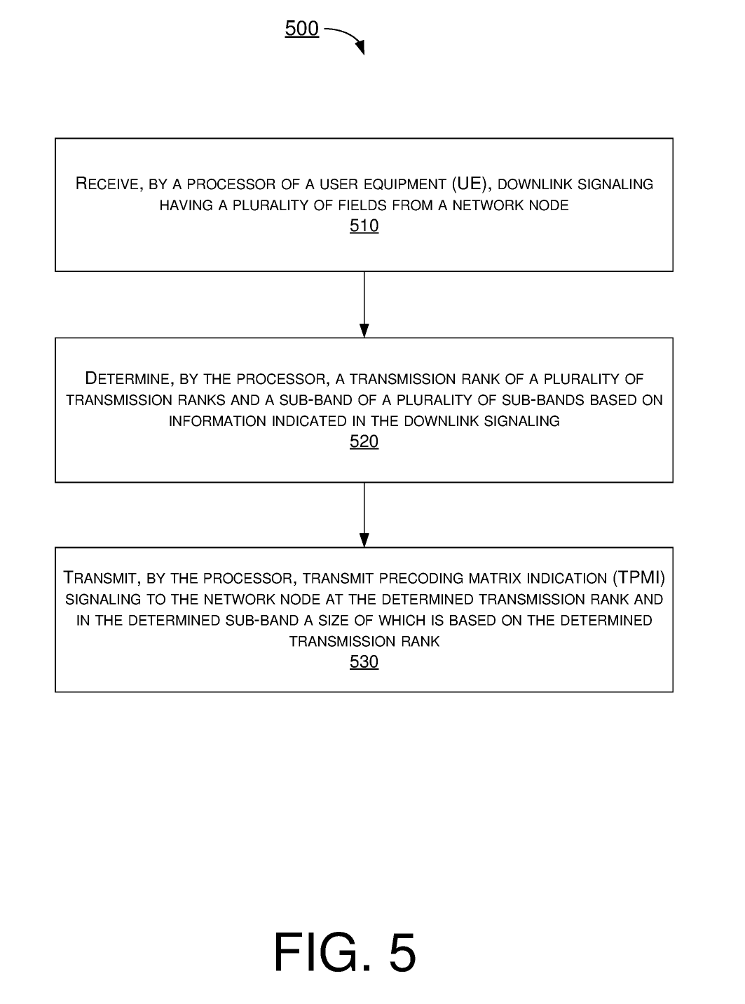

In some implementations, memory 320 may be a storage device configured to store one or more sets of codes, programs and/or instructions and/or data therein. In the example shown in FIG. 5, memory 320 stores one or more sets of processor-executable instructions 322 and data 324 therein. Memory 320 may be implemented by any suitable technology and may include volatile memory and/or non-volatile memory. For example, memory 320 may include a type of random access memory (RAM) such as dynamic RAM (DRAM), static RAM (SRAM), thyristor RAM (T-RAM) and/or zero-capacitor RAM (Z-RAM). Alternatively or additionally, memory 320 may include a type of read-only memory (ROM) such as mask ROM, programmable ROM (PROM), erasable programmable ROM (EPROM) and/or electrically erasable programmable ROM (EEPROM). Alternatively or additionally, memory 320 may include a type of non-volatile random-access memory (NVRAM) such as flash memory, solid-state memory, ferroelectric RAM (FeRAM), magnetoresistive RAM (MRAM) and/or phase-change memory.

In some implementations, transceiver 330 may include a plurality of power amplifiers 332(1)˜332(N) and a plurality of antenna ports 334(1)˜334(N) each corresponding to a respective one of the power amplifiers 332(1)˜332(N) that correspond to the plurality of antennas 336(1)˜336(N). Transceiver 330 may be configured to establish wireless communications with wireless network 350 via network node 340 by radiating and receiving wireless signals (e.g., multiple-input-and-multiple-output (MIMO) signals) through antennas 336(1)˜336(N). Transceiver 330 may be configured to communicate wirelessly in a single frequency sub-band or multiple frequency sub-bands. Transceiver 330 may be capable of transmitting data and signals wirelessly and receiving data and signals wirelessly. In some implementations, transceiver 330 may be capable of transmitting/modulating and receiving/demodulating data symbols as orthogonal frequency-division multiplexed (OFDM) symbols that are radiated through one or more of antennas 336(1)˜336(N).

In some implementations, processor 310 may be implemented in the form of one or more single-core processors, one or more multi-core processors, or one or more CISC processors. That is, even though a singular term “a processor” is used herein to refer to processor 310, processor 310 may include multiple processors in some implementations and a single processor in other implementations in accordance with the present disclosure. In another aspect, processor 310 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 310 is a special-purpose machine specifically designed, arranged and configured to perform specific tasks including UL transmission in mobile communications in accordance with various implementations of the present disclosure.

Processor 310, as a special-purpose machine, may include non-generic and specially-designed hardware circuits that are designed, arranged and configured to perform specific tasks pertaining to UL transmission in mobile communications in accordance with various implementations of the present disclosure. In one aspect, processor 310 may execute the one or more sets of codes, programs and/or instructions 322 stored in memory 320 to perform various operations to render UL transmission in mobile communications in accordance with various implementations of the present disclosure.

In some implementations, processor 310 may receive, via transceiver 330, downlink signaling having a plurality of fields from network node 340. Processor 310 may determine a transmission rank of a plurality of transmission ranks, a sub-band of a plurality of sub-bands based on information indicated in the downlink signaling, and transmit precoding matrix for each sub-band according to TPMI signaling within the downlink signaling from network node 340 at the determined transmission rank and in the determined sub-band a size of which is based on the determined transmission rank. Additionally, processor 310 may transmit, via transceiver 330, a reference signal to network node 340 via the plurality of antenna ports 334(1)˜334(N). Moreover, processor 310 may transmit, via transceiver 330, data through a PUSCH to network node 340 via the plurality of antenna ports 334(1)˜334(N). Furthermore, processor 310 may control output powers of the plurality of power amplifiers 332(1)˜332(N) such that, for at least a first antenna of the plurality of antennas 336(1)˜336(N), an amount of power used by the first antenna in transmitting the data and another amount of power used by the first antenna in transmitting the reference signal are equal.

In some implementations, in controlling the plurality of amplifiers 332(1)˜332(N), processor 310 may control output powers of the plurality of power amplifiers 332(1)˜332(N) such that, for at least a first antenna of the plurality of antennas 336(1)˜336(N), an amount of power used by the first antenna in transmitting the data and another amount of power used by the first antenna in transmitting the reference signal are equal.

In some implementations, in transmitting the reference signal to network node 340 340, processor 310 may perform, via transceiver 330, a beamformed sounding reference signal (SRS) transmission to network node 340.

In some implementations, in controlling the plurality of amplifiers 332(1)˜332(N), processor 310 may control an output power of each power amplifier of the plurality of power amplifiers 332(1)˜332(N) such that an amount of power used by each antenna of the plurality of antennas 336(1)˜336(N) in performing the beamformed SRS transmission is equal to an amount of power used by another antenna of the plurality of antennas 336(1)˜336(N) in performing the beamformed SRS transmission.

In some implementations, in performing the beamformed SRS transmission, processor 310 may apply a precoding matrix on the beamformed SRS. Moreover, in transmitting of the data through the PUSCH, processor 310 may perform the following: (1) selecting a transmission rank used for transmitting the data; (2) determining one or more power scaling factors corresponding to the transmission rank in transmitting the data; and (3) applying a precoding matrix, which is equal to the precoding matrix for the beamformed SRS multiplied by a power-scaled beam-selection matrix, to transmit data on PUSCH.

In some implementations, the transmission rank selected for transmitting the data may be rank i. In some implementations, an i-th column in the precoding matrix for layer i may include an all-zero vector except one component being 1 at a row that is scaled by a respective power scaling factor associated with layer i.

In some implementations, processor 310 may be capable of applying k power scaling factors to adjust an amount of power used by each antenna of the plurality of antennas in transmitting the PUSCH with k layers to be equal to an amount of power used by each antenna of the plurality of antennas in performing the beamformed SRS transmission.

In some implementations, in performing the beamformed SRS, processor 310 may perform the following: (1) measuring one or more reference signals transmitted from the network node; (2) estimating an uplink covariance matrix according to the measuring of the one or more reference signals transmitted from the network node; (3) performing eigen value decomposition on the uplink covariance matrix to derive one or more eigen-vectors; (4) selecting at least one vector from the one or more eigen-vectors to form a precoding matrix; (5) scaling all matrix elements of the precoding matrix such that the matrix elements are of a same power; and (6) encoding the SRS transmission using the precoding matrix.

In some implementations, in transmitting, processor 310 may perform a codebook-based UL MIMO transmission. Furthermore, in transmitting the reference signal to network node 340, processor 310 may perform the following: (1) normalizing a precoder to generate a normalized precoder; and (2) transmitting the reference signal to network node 340 using the normalized precoder.

In some implementations, the plurality of fields in the downlink signaling may include a transmission rank indication field, a TPMI field composed by one or more sub-band TPMI indication fields. Additionally, a number of the one or more sub-band TPMI indication fields may be a function of a transmission rank indicated in the transmission rank indication field. Moreover, a size of each of the transmission rank indication field and the TPMI field may be fixed.

In some implementations, different sizes of sub-bands of the plurality of sub-bands may correspond to different transmission ranks of the plurality of transmission ranks such that a sub-band of a smaller size corresponds to at least one transmission rank of the plurality of transmission ranks and another sub-band of a larger size corresponds to at least another transmission rank of the plurality of transmission ranks.

In some implementations, the plurality of transmission ranks may include rank 1, rank 2, rank 3, rank 4, rank 5, rank 6, rank 7 and rank 8. Moreover, a number of bits per sub-band for TPMI at rank 1 or rank 2 may be greater than a number of bits per sub-band for TPMI at any of rank 3, rank 4, rank 5, rank 6, rank 7 or rank 8.

In some implementations, in receiving the downlink signaling, processor 310 may receive, via transceiver 330, a downlink control indicator (DCI) or a media access control (MAC) control element (CE) from network node 340.

### Illustrative Processes

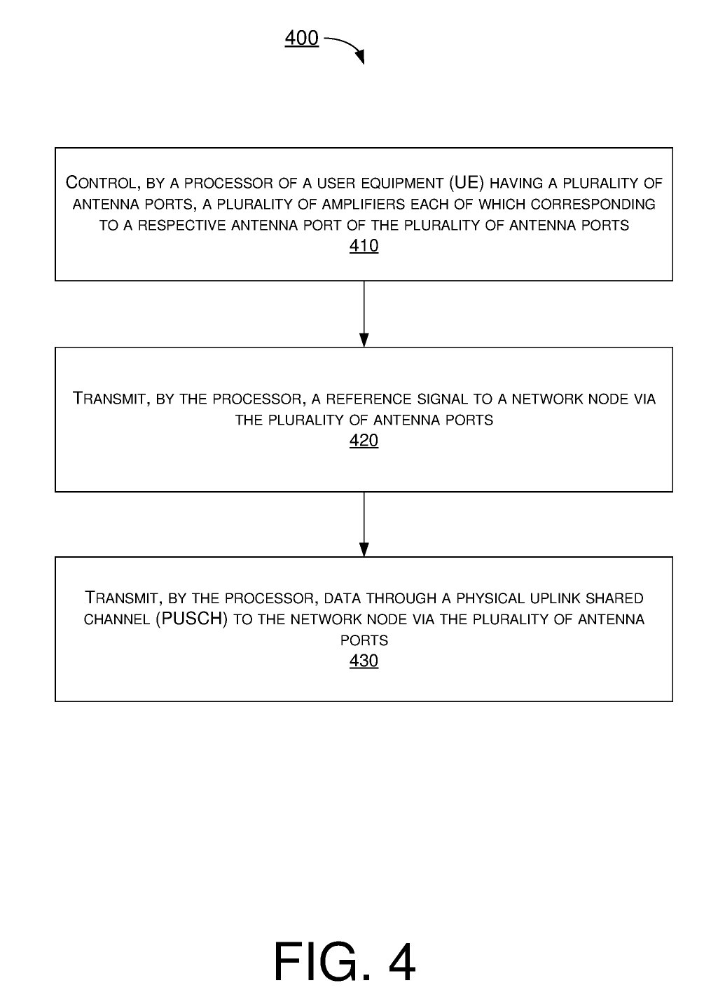

FIG. 4 illustrates an example process 400 of wireless communication in accordance with an implementation of the present disclosure. Process 400 may represent an aspect of implementing the proposed concepts and schemes such as those described above. More specifically, process 400 may represent an aspect of the proposed concepts and schemes pertaining to UL transmission in mobile communications. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Process 400 may be implemented by communications system 300 and any variations thereof. For instance, process 400 may be implemented in or by apparatus 305 as a UE. Solely for illustrative purposes and without limiting the scope, process 400 is described below in the context of first apparatus 305. Process 400 may begin at block 410.

At 410, process 400 may involve processor 310 controlling a plurality of amplifiers 332(1)˜332(N) each of which corresponding to a respective antenna port of a plurality of antenna ports 334(1)˜334(N), with N being a positive integer greater 1. Process 400 may proceed from 410 to 420.

At 420, process 400 may involve processor 310 transmitting, via transceiver 330, a reference signal to network node 340 via the plurality of antenna ports 334(1)˜334(N) and a plurality of antennas 336(1)˜336(N). Process 400 may proceed from 420 to 430.

At 430, process 400 may involve processor 310 transmitting, via transceiver 330, data through a physical uplink shared channel (PUSCH) to network node 340 via the plurality of antenna ports 334(1)˜334(N).

In some implementations, in controlling the plurality of amplifiers 332(1)˜332(N), process 400 may involve processor 310 controlling output powers of the plurality of power amplifiers 332(1)˜332(N) such that, for at least a first antenna of the plurality of antennas 336(1)˜336(N), an amount of power used by the first antenna in transmitting the data and another amount of power used by the first antenna in transmitting the reference signal are equal.

In some implementations, in transmitting the reference signal to network node 340, process 400 may involve processor 310 performing, via transceiver 330, a beamformed sounding reference signal (SRS) transmission to network node 340.

In some implementations, in controlling the plurality of amplifiers 332(1)˜332(N), process 400 may involve processor 310 controlling an output power of each power amplifier of the plurality of power amplifiers 332(1)˜332(N) such that an amount of power used by each antenna of the plurality of antennas 336(1)˜336(N) in performing the beamformed SRS transmission is equal to an amount of power used by another antenna of the plurality of antennas 336(1)˜336(N) in performing the beamformed SRS transmission. That is, all antennas 336(1)˜336(N) may use an equal amount of power per channel in performing the beamformed SRS transmission.

In some implementations, in performing the beamformed SRS transmission, process 400 may involve processor 310 applying a precoding matrix to form the beamformed SRS. Moreover, in transmitting the data through the PUSCH, process 400 may involve processor 310 performing the following: (1) selecting a transmission rank k used for transmitting the data by k layers; (2) applying k power scaling factors corresponding to the transmission rank k in transmitting the data; and (3) applying another precoding matrix for the PUSCH transmission based on a selection from vectors composing the precoding matrix used to form the beamformed SRS and the power scaling factors. Alternatively, in transmitting the data through the PUSCH, process 400 may involve processor 310 performing the following: (1) selecting a transmission rank used for transmitting the data; (2) determining one or more power scaling factors corresponding to the transmission rank in transmitting the data; and (3) applying a precoding matrix, which is equal to the precoding matrix for the beamformed SRS multiplied by a power-scaled beam-selection matrix, to transmit data on PUSCH.

In some implementations, in applying the k power scaling factors, process 400 may involve processor 310 applying the k power scaling factors to adjust an amount of power used by each antenna of the plurality of antennas 336(1)˜336(N) in transmitting the PUSCH to be equal to an amount of power used by each antenna of the plurality of antennas 336(1)˜336(N) in performing the beamformed SRS transmission.

In some implementations, the transmission rank selected for transmitting the data may be rank k. In some implementations, an i-th column with 1≤i≤k in the precoding matrix for PUSCH transmission may include a vector of an all-zero vector except one component being 1 at a row that is scaled by a respective power scaling factor associated with layer i.

In some implementations, in performing the beamformed SRS, process 400 may involve processor 310 performing the following: (1) measuring one or more reference signals transmitted from the network node; (2) estimating an uplink covariance matrix according to the measuring of the one or more reference signals transmitted from the network node; (3) performing eigen value decomposition on the uplink covariance matrix to derive one or more eigen-vectors; (4) selecting at least one vector from the one or more eigen-vectors to form a precoding matrix; (5) scaling all matrix elements of the precoding matrix such that the matrix elements are of a same power; and (6) encoding the SRS transmission using the precoding matrix.

In some implementations, in transmitting, process 400 may involve processor 310 performing uplink (UL) multiple-input-and-multiple-output (MIMO) transmission. Furthermore, in transmitting the reference signal to network node 340, process 400 may involve processor 310 performing the following: (1) normalizing a precoder to generate a normalized precoder; and (2) transmitting the reference signal to network node 340 using the normalized precoder.

FIG. 5 illustrates an example process 500 of wireless communication in accordance with an implementation of the present disclosure. Process 500 may represent an aspect of implementing the proposed concepts and schemes such as those described above. More specifically, process 500 may represent an aspect of the proposed concepts and schemes pertaining to UL transmission in mobile communications. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Process 500 may be implemented by communications system 300 and any variations thereof. For instance, process 500 may be implemented in or by apparatus 305 as a UE. Solely for illustrative purposes and without limiting the scope, process 500 is described below in the context of first apparatus 305. Process 500 may begin at block 510.

At 510, process 500 may involve processor 310 receiving, via transceiver 330, downlink signaling having a plurality of fields from network node 340. Process 500 may proceed from 510 to 520.

At 520, process 500 may involve processor 310 determining a transmission rank of a plurality of transmission ranks and a sub-band of a plurality of sub-bands based on information indicated in the downlink signaling. Process 500 may proceed from 520 to 530.

At 530, process 500 may involve processor 310 transmitting, via transceiver 330, transmit precoding matrix indication (TPMI) signaling to network node 340 at the determined transmission rank and in the determined sub-band a size of which is based on the determined transmission rank.

In some implementations, the plurality of fields in the downlink signaling may include a transmission rank indication field and a TPMI field composed by one or more sub-band TPMI indication fields. Additionally, a number of the one or more sub-band TPMI indication fields may be a function of a transmission rank indicated in the transmission rank indication field. Moreover, a size of each of the transmission rank indication field and the TPMI field may be fixed.

In some implementations, different sizes of sub-bands of the plurality of sub-bands may correspond to different transmission ranks of the plurality of transmission ranks such that a sub-band of a smaller size corresponds to at least one transmission rank of the plurality of transmission ranks and another sub-band of a larger size corresponds to at least another transmission rank of the plurality of transmission ranks.

In some implementations, the plurality of transmission ranks may include rank 1, rank 2, rank 3, rank 4, rank 5, rank 6, rank 7 and rank 8. Moreover, a number of bits per sub-band for TPMI at rank 1 or rank 2 may be greater than a number of bits per sub-band for TPMI at any of rank 3, rank 4, rank 5, rank 6, rank 7 or rank 8.

In some implementations, in receiving the downlink signaling, process 500 may involve processor 310 receiving a downlink control indicator (DCI) or a media access control (MAC) control element (CE) from network node 340.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method of wireless communication, comprising:
controlling, by a processor of a user equipment (UE) having a plurality of antenna ports, a plurality of amplifiers each of which corresponding to a respective antenna port of the plurality of antenna ports that correspond to a plurality of antennas;
transmitting, by the processor, a reference signal to a network node via the plurality of antenna ports; and
transmitting, by the processor, data through a physical uplink shared channel (PUSCH) to the network node via the plurality of antenna ports,
wherein the controlling comprises controlling output powers of the plurality of power amplifiers such that, for at least a first antenna of the plurality of antennas, an amount of power used by the first antenna in transmitting the data and another amount of power used by the first antenna in transmitting the reference signal are equal.

2. The method of claim 1, wherein the transmitting of the reference signal to the network node comprises performing a beamformed sounding reference signal (SRS) transmission to the network node.

3. The method of claim 2, wherein the controlling comprises controlling an output power of each power amplifier of the plurality of power amplifiers such that all antennas of the plurality of antennas use an equal amount of power per antenna in performing the beamformed SRS transmission.

4. The method of claim 2, wherein the performing of the beamformed SRS transmission comprises applying a precoding matrix to form the beamformed SRS, and wherein the transmitting of the data through the PUSCH comprises:
selecting a transmission rank k used for transmitting the data by k layers;
applying k power scaling factors corresponding to the transmission rank k in transmitting the data; and
applying another precoding matrix for the PUSCH transmission based on a selection from vectors composing the precoding matrix used to form the beamformed SRS and the power scaling factors.

5. The method of claim 4, wherein the applying of the k power scaling factors comprises applying the k power scaling factors to adjust an amount of power used by each antenna of the plurality of antennas in transmitting the PUSCH to be equal to an amount of power used by each antenna of the plurality of antennas in performing the beamformed SRS transmission.

6. The method of claim 4, wherein the transmission rank selected for transmitting the data is rank k, and wherein an i-th column with 1≤i≤k in the precoding matrix for PUSCH transmission comprises a vector of an all-zero vector except one component being 1 at a row further multiplied by the power scaling factor for an i-th layer.

7. The method of claim 2, wherein the performing of the beamformed SRS comprises:
measuring one or more reference signals transmitted from the network node;
estimating an uplink covariance matrix according to the measuring of the one or more reference signals transmitted from the network node;
performing eigen value decomposition on the uplink covariance matrix to derive one or more eigen-vectors;
selecting at least one vector from the one or more eigen-vectors to form a precoding matrix;
scaling all matrix elements of the precoding matrix such that the matrix elements are of a same power; and
encoding the SRS transmission using the precoding matrix.

8. A method of wireless communication, comprising:
receiving, by a processor of a user equipment (UE), downlink signaling having a plurality of fields from a network node;
determining, by the processor, a transmission rank of a plurality of transmission ranks and a sub-band of a plurality of sub-bands based on information indicated in the downlink signaling; and
transmitting, by the processor, transmit precoding matrix indication (TPMI) signaling to the network node at the determined transmission rank and in the determined sub-band a size of which is based on the determined transmission rank.

9. The method of claim 8, wherein the plurality of fields in the downlink signaling comprises a transmission rank indication field, a TPMI field composed by one or more sub-band TPMI indication fields, wherein a number of the one or more sub-band TPMI indication fields is a function of a transmission rank indicated in the transmission rank indication field, and wherein a size of each of the transmission rank indication field and the TPMI field is fixed.

10. The method of claim 8, wherein different sizes of sub-bands of the plurality of sub-bands correspond to different transmission ranks of the plurality of transmission ranks such that a sub-band of a smaller size corresponds to at least one transmission rank of the plurality of transmission ranks and another sub-band of a larger size corresponds to at least another transmission rank of the plurality of transmission ranks.

11. The method of claim 8, wherein the plurality of transmission ranks comprises rank 1, rank 2, rank 3, rank 4, rank 5, rank 6, rank 7 and rank 8, and wherein a number of bits per sub-band for TPMI at rank 1 or rank 2 is greater than a number of bits per sub-band for TPMI at any of rank 3, rank 4, rank 5, rank 6, rank 7 or rank 8.

12. The method of claim 8, wherein the receiving of the downlink signaling comprises receiving a downlink control indicator (DCI) or a media access control (MAC) control element (CE) from the network node.

13. An apparatus, comprising:
a transceiver comprising a plurality of power amplifiers and a plurality of antenna ports each corresponding to a respective one of the power amplifiers that correspond to a plurality of antennas, the transceiver capable of wirelessly communicating with a network node via the plurality of antenna ports; and
a processor communicatively coupled to the transceiver, the processor capable of:
receiving, via the transceiver, downlink signaling having a plurality of fields from the network node;
determining a transmission rank of a plurality of transmission ranks, a sub-band of a plurality of sub-bands based on information indicated in the downlink signaling and transmit a precoding matrix for each sub-band according to transmit precoding matrix indication (TPMI) signaling within the downlink signaling from the network node at the determined transmission rank and in the determined sub-band a size of which is based on the determined transmission rank;
transmitting, via the transceiver, a reference signal to the network node via the plurality of antenna ports; and
transmitting, via the transceiver, data through a physical uplink shared channel (PUSCH) to the network node via the plurality of antenna ports.

14. The apparatus of claim 13, wherein the plurality of fields in the downlink signaling comprises a transmission rank indication field and a TPMI field composed by one or more sub-band TPMI indication fields, wherein a number of the one or more sub-band TPMI indication fields is a function of a transmission rank indicated in the transmission rank indication field, and wherein a size of each of the transmission rank indication field and the TPMI field is fixed.

15. The apparatus of claim 13, wherein different sizes of sub-bands of the plurality of sub-bands correspond to different transmission ranks of the plurality of transmission ranks such that a sub-band of a smaller size corresponds to at least one transmission rank of the plurality of transmission ranks and another sub-band of a larger size corresponds to at least another transmission rank of the plurality of transmission ranks.

16. The apparatus of claim 13, wherein, in transmitting the reference signal to the network node, the processor performs a beamformed sounding reference signal (SRS) transmission to the network node, and wherein, in controlling the output powers of the plurality of power amplifiers, the processor controls an output power of each power amplifier of the plurality of power amplifiers such that an amount of power used by each antenna of the plurality of antennas in performing the beamformed SRS transmission is equal to an amount of power used by another antenna of the plurality of antennas in performing the beamformed SRS transmission.

17. The apparatus of claim 13, wherein, in transmitting the reference signal to the network node, the processor performs a beamformed sounding reference signal (SRS) transmission to the network node, wherein, in performing the beamformed SRS transmission, the processor applies a precoding matrix on the beamformed SRS, and wherein, in transmitting the data through the PUSCH, the processor performs operations comprising:
selecting a transmission rank used for transmitting the data;
determining one or more power scaling factors corresponding to the transmission rank in transmitting the data; and
applying a precoding matrix, which is equal to the precoding matrix for the beamformed SRS multiplied by a power-scaled beam-selection matrix, to transmit data on PUSCH.

18. The apparatus of claim 17, wherein the transmission rank selected for transmitting the data is rank k, and wherein an i-th column with 1≤i≤k in the power-scaled beam-selection matrix for layer i comprises an all-zero vector except one component being 1 at a row that is scaled by a respective power scaling factor associated with layer i.

19. The apparatus of claim 18, wherein the processor is capable of applying k power scaling factors to adjust an amount of power used by each antenna of the plurality of antennas in transmitting the PUSCH to be equal to an amount of power used by each antenna of the plurality of antennas in performing the beamformed SRS transmission.

20. The apparatus of claim 13, wherein, in transmitting the reference signal to the network node, the processor performs a beamformed sounding reference signal (SRS) transmission to the network node, and wherein, in performing the beamformed SRS transmission, the processor performs operations comprising:
measuring one or more reference signals transmitted from the network node;
estimating an uplink covariance matrix according to the measuring of the one or more reference signals transmitted from the network node;
performing eigen value decomposition on the uplink covariance matrix to derive one or more eigen-vectors;
selecting at least one vector from the one or more eigen-vectors to form a precoding matrix;
scaling all matrix elements of the precoding matrix such that the matrix elements are of a same power; and
encoding the SRS transmission using the precoding matrix.
